(19) United States
(12) Patent Application Publication
(10) Pub. No.: US 2017/0161607 A1
(43) Pub. Date: Jun. 8, 2017

(54) SYSTEM AND METHOD FOR IMPROVED GESTURE RECOGNITION USING NEURAL NETWORKS

(71) Applicant: Pilot AI Labs, Inc., Sunnyvale, CA (US)

(72) Inventors: Elliot English, Stanford, CA (US); Ankit Kumar, San Diego, CA (US); Brian Pierce, Santa Clara, CA (US); Jonathan Su, San Jose, CA (US)

(21) Appl. No.: 15/369,743

(22) Filed: Dec. 5, 2016

Related U.S. Application Data
(60) Provisional application No. 62/263,600, filed on Dec. 4, 2015.

(51) Int. Cl. G06N 3/08; G06N 5/04; G06F 3/01

(52) U.S. Cl. CPC G06N 3/08; G06F 3/017; G06N 5/04

(57) ABSTRACT

According to various embodiments, a method for gesture recognition using a neural network is provided. The method comprises a training mode and an inference mode. In the training mode, the method includes: passing a dataset into the neural network; and training the neural network to recognize a gesture of interest, wherein the neural network includes a convolution-nonlinearity step and a recurrent step. The inference mode, the method includes: passing a series of images into the neural network, wherein the series of images is not part of the dataset; and recognizing the gesture of interest in the series of images.

### CROSS REFERENCE TO RELATED APPLICATIONS

This application claims priority under 35 U.S.C. §119(e) to U.S. Provisional Application No. 62/263,600, filed Dec. 4, 2015, entitled SYSTEM AND METHOD IMPROVED GESTURE RECOGNITION USING NEURAL NETWORKS, the contents of which are hereby incorporated by reference.

### TECHNICAL FIELD

The present disclosure relates generally to machine learning algorithms, and more specifically to recognizing gestures using machine learning algorithms.

### BACKGROUND

Systems have attempted to use various neural networks and computer learning algorithms to identify gestures within an image or a series of images. However, existing attempts to identify gestures are not successful because the methods of pattern recognition and estimating location of objects are inaccurate and non-general. Furthermore, existing systems attempt to identify gestures by some sort of pattern recognition that is too specific, or not sufficiently adaptable. Thus, there is a need for an enhanced method for training a neural network to detect and identify gestures of interest with increased accuracy by utilizing improved computational operations.

### SUMMARY

The following presents a simplified summary of the disclosure in order to provide a basic understanding of certain embodiments of the present disclosure. This summary is not an extensive overview of the disclosure and it does not identify key/critical elements of the present disclosure or delineate the scope of the present disclosure. Its sole purpose is to present some concepts disclosed herein in a simplified form as a prelude to the more detailed description that is presented later.

In general, certain embodiments of the present disclosure provide techniques or mechanisms for improved object detection by a neural network. According to various embodiments, a method for gesture recognition using a neural network is provided. The method comprises a training mode and an inference mode. In the training mode, the method includes passing a dataset into the neural network, and training the neural network to recognize a gesture of interest. The dataset may comprise a random subset of a video with known gestures of interest. During the training mode, parameters in the neural network may be updated using a stochastic gradient descent.

In the inference mode, the method includes passing a series of images into the neural network, and recognizing the gesture of interest in the series of images. The series of images may not be part of the dataset.

The neural network may include a convolution-nonlinearity step and a recurrent step. The convolution-nonlinearity step comprises a convolution layer and a rectified linear layer. The convolution-nonlinearity step may comprise a plurality of convolution-nonlinearity layer pairs, each convolution-nonlinearity layer pair comprising a convolution layer followed by a rectified linear layer. The convolution-nonlinearity step takes a third-order tensor as input and outputs a feature tensor.

The recurrent step comprises a concatenation layer followed by a convolution layer. The concatenation layer make take two third-order tensors as input and outputs a concatenated third-order tensor. The convolution layer may take the concatenated third-order tensor as input and outputs a recurrent convolution layer output. The recurrent convolution layer output may be inputted into a linear layer in order to produce a linear layer output. The linear layer output being a first-order tensor with a specific dimension corresponding to the number of gestures of interest. The linear layer output may then be input into a sigmoid layer. The sigmoid layer transforms each output from the linear layer into a probability that a given gesture occurs within a current frame. During the recurrent step, a current frame may depend on its own feature tensor and the feature tensor from all the frames preceding the current frame.

In another embodiment, a system for gesture recognition using a neural network is provided. The system includes one or more processors, memory, and one or more programs stored in the memory. The one or more programs comprise instructions to operate in a training mode and an inference mode. In the training mode, the one or more programs comprise instructions for passing a dataset into the neural network, and training the neural network to recognize a gesture of interest. The neural network includes a convolution-nonlinearity step and a recurrent step. In the inference mode, the one or more programs comprise instructions for passing a series of images into the neural network, and recognizing the gesture of interest in the series of images. The series of images may not be part of the dataset.

In yet another embodiment, a non-transitory computer readable medium is provided. The computer readable medium storing one or more programs comprise instructions to operate in a training mode and an inference mode. In the training mode, the one or more programs comprise instructions for passing a dataset into the neural network, and training the neural network to recognize a gesture of interest. The neural network includes a convolution-nonlinearity step and a recurrent step. In the inference mode, the one or more programs comprise instructions for passing a series of images into the neural network, and recognizing the gesture of interest in the series of images. The series of images may not be part of the dataset.

These and other embodiments are described further below with reference to the figures.

### BRIEF DESCRIPTION OF THE DRAWINGS

The disclosure may best be understood by reference to the following description taken in conjunction with the accompanying drawings, which illustrate particular embodiments of the present disclosure.

FIGS. 1A and 1B illustrate a particular example of computational layers implemented in a neural network, in accordance with one or more embodiments.

FIGS. 2A, 2B, and 2C illustrate an example of a method for gesture recognition using a neural network, in accordance with one or more embodiments.

FIG. 3 illustrates one example of a neural network system that can be used in conjunction with the techniques and mechanisms of the present disclosure in accordance with one or more embodiments.

### DETAILED DESCRIPTION OF PARTICULAR EMBODIMENTS

Reference will now be made in detail to some specific examples of the present disclosure including the best modes contemplated by the inventors for carrying out the present disclosure. Examples of these specific embodiments are illustrated in the accompanying drawings. While the present disclosure is described in conjunction with these specific embodiments, it will be understood that it is not intended to limit the present disclosure to the described embodiments. On the contrary, it is intended to cover alternatives, modifications, and equivalents as may be included within the spirit and scope of the present disclosure as defined by the appended claims.

For example, the techniques of the present disclosure will be described in the context of particular algorithms. However, it should be noted that the techniques of the present disclosure apply to various other algorithms. In the following description, numerous specific details are set forth in order to provide a thorough understanding of the present disclosure. Particular example embodiments of the present disclosure may be implemented without some or all of these specific details. In other instances, well known process operations have not been described in detail in order not to unnecessarily obscure the present disclosure.

Various techniques and mechanisms of the present disclosure will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present disclosure unless otherwise noted. Furthermore, the techniques and mechanisms of the present disclosure will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

According to various embodiments, a method for gesture recognition using a neural network is provided. The method comprises a training mode and an inference mode. In the training mode, a dataset, which may comprise a random subset of a video with known gestures of interest, is passed into the neural network. The neural network may then be trained to recognize a gesture of interest.

Once sufficiently trained, the neural network may be configured to operate in an inference mode. In the inference mode, a series of images into the neural network. Such series of images is may not be part of the dataset used during the training mode. The neural network may then recognize the gesture of interest in the series of images.

In various embodiments, the neural network includes a convolution-nonlinearity step and a recurrent step. The convolution-nonlinearity step includes a convolution layer and a rectified linear layer. In some embodiments, the convolution-nonlinearity step comprises a plurality of convolution-nonlinearity layer pairs. Each convolution-nonlinearity pair comprising a convolution layer followed by a rectified linear layer. In various embodiments, the recurrent step may comprise a concatenation layer, followed by a convolution layer, followed by a linear layer, followed by a sigmoid layer. The sigmoid layer may transform each output from the linear layer into a probability that a given gesture occurs within a current frame. In the training mode, the determined probability may be compared to the known gesture within an image frame and the parameters of the neural network are updated using a stochastic gradient descent.

### Example Embodiments

In various embodiments, the system for gesture detection uses a labeled dataset of gesture sequences to train the parameters of a neural network so that the network can predict whether or not a gesture is occurring during a given image within a sequence of images. For the neural network, the input is a sequence of images. For each image within the sequence, a list of gestures that are occurring within that image is given. However a single training “example” consists of the entire sequence. More details about how sequences are chosen are presented below.

In some embodiments, the network is composed of multiple types of layers. The layers can be categorized into a “convolution non-linearity layer/step” and a “recurrent convolution layer/step.” The later layer (or step) is created because it is well suited for the task of predicting something from a sequence of images.

Description of the System in High-Level Steps

In various embodiments, the system begins with a “convolution nonlinearity” step. This step takes as input each individual image and produces a third-order tensor for each image. The purpose of this step is to allow the neural network to transform the raw input pixels of each image into features which are more useful for the task at hand (gesture recognition). In some embodiments, the system for producing the features includes the “convolution nonlinearity” step, which is a sequence of “convolution layer->rectified-linear layer pairs.” In some embodiments, the parameters of all the layers within the first step begin as random values, and will slowly be trained using stochastic gradient descent. In some embodiments, the parameters will be trained on a dataset that includes a sequence of images with gesture labels.

The “convolution nonlinearity” step is followed by the recurrent step which goes through the feature tensors of the previous step for each image within the sequence, predicting whether or not any of the gestures of interest occur within that image. The step is set up such that each frame depends on the feature tensor from its own image as well as the feature tensor from all the images preceding itself in the sequence.

In various embodiments, the system may identify various objects, such as fingers, hands, arms, and/or faces, and track such objects for the task of gesture recognition. At least a portion of the neural network system described herein may work in conjunction with various other types of systems for object identification and tracking to predict gestures. For example, object detection may be performed by a neural network detection system described in the U.S. patent application titled SYSTEM AND METHOD FOR IMPROVED GENERAL OBJECT DETECTION USING NEURAL NETWORKS filed on Nov. 30, 2016 which claims priority to U.S. Provisional Application No. 62/261,260, filed Nov. 30, 2015, of the same title, each of which are hereby incorporated by reference. Object tracking may be performed by a tracking system as described in the U.S. patent application entitled SYSTEM AND METHOD FOR DEEP-LEARNING BASED OBJECT TRACKING filed on Dec. 2, 2016 which claims priority to U.S. Provisional Application No. 62/263,611, filed on Dec. 4, 2015, of the same title, each of which are hereby incorporated by reference.

In yet further embodiments, distance and velocity of an object, such as a hand and/or finger(s) may be estimated for use in gesture recognition. Such distance and velocity estimation may be performed by a distance estimation system as described in the U.S. patent application entitled SYSTEM AND METHOD FOR IMPROVED DISTANCE ESTIMATION OF DETECTED OBJECTS filed on Dec. 5, 2016 which claims priority to U.S. Provisional Application No. 62/263,496, filed Dec. 4, 2015, of the same title, each of which are hereby incorporated by reference.

Details about the Layers within the Steps

In various embodiments, the feature tensor which is the output of the “convolution nonlinearity” step is fed into the recurrent step. The recurrent step consists of a few different layers. The third order feature tensor and the output of the previous image's (in the sequence) “recurrent convolution layer” are fed into the “recurrent convolution layer” for the current image (details of the “recurrent convolution layer” to follow). The output of the “recurrent convolution” layer is fed into a linear layer. The dimension of the first-order tensor which is output of the linear layer is equivalent to the number of gestures of interest. The linear layer is fed into an element-wise sigmoid layer, whose output values are taken as the probability that each gesture of interest occurs in the current image (there is one value per gesture of interest).

In various embodiments, the “recurrent convolution layer” is a combination of two simpler layers. In particular, the “recurrent convolution layer” serves to combine the features and information from all previous images in the sequence with the current image. In some embodiments, the dependence on all the previous frames is only implicit, as it explicitly only depends on the features from the current frame and the immediately previous frame (of these, the immediately previous frame depends on two previous frames, and so on).

The “recurrent convolution layer” begins with a “concatenation layer”, which takes the two (2) third-order tensor inputs and concatenates them. The tensor inputs must have the same “height” and “width” dimensions, because the concatenation is performed on the channel dimension. In practice, all 3 dimensions of the third order tensor match for the problem. The output of the “concatenation layer” is another third order tensor, whose height and width match that of the inputs, but which has a number of channels equal to the sum of the number of input channels from the two input tensors. The output of the concatenation layer is fed into a “convolution layer.” The “convolution layer” component of the “recurrent convolution layer” is the last component, and therefore the output of the “convolution layer” is taken as the output of the “recurrent convolution layer”.

In various embodiments, there is a reason for utilizing this type of recurrence. In some embodiments, the purpose is to enforce the connections between the tensor from the previous frame and the tensor from the current frame to be local connections. In some embodiments, using a “linear recurrent layer” or a “quadratic recurrent layer” would still result in dense connections between the tensor associated with the previous frame and the tensor associated with the current frame. However, the network will learn the parameters more efficiently if the dependency is kept local by using a convolutional type of recurrence. As used herein, “local” dependency refers to systems where the output is only dependent upon a small subset of the input.

This network arrangement allows a majority of the computation to be done on a single current frame. However, at the same time a compact tensor from a previous image is passed into the recurrent convolution layer which provides context from previous frames to the current frame, without having to pass all the previous frames, which may become computationally intense. For example, with a 1080p video frame, this network arrangement may utilize at least 1,000 times less computational resource expenditure. The tensor output by the recurrent convolution layer for the current frame may then be transmitted to the recurrent convolution layer for the subsequent frame. In this way, the output tensor of a recurrent convolution layer is passed from one frame to the next, and may represent the passage of information from one frame to the next. Such tensor may be a result of a function of the training process.

In some embodiments, the output of the “recurrent convolution layer” is also fed into a linear layer, whose output is in turn fed into a sigmoid layer. The reasoning behind the linear layer is to take the tensor which is output from the “recurrent convolution layer” and transform it to a first-order tensor with a specific dimension, which is equal to the number of gestures of interest. The purpose of the sigmoid layer is to transform each value from the output of the linear layer into a number between 0 and 1, which can be interpreted as a probability that a given gesture occurs within the current frame.

Description of the Original Dataset and how Sequences are Taken from the Original Data

As was mentioned above, the neural network is trained using stochastic gradient descent, on a dataset of sequences. In practice, input can often be a long video which contains many examples of the sequences of interest. However in training, it may not be computationally feasible to load an entire long video and treat it as a single example. Therefore in some embodiments, for each sample, a random subset of one of the videos is taken and that subset as the sequence for training is used as the training input. This method of perturbing the input data in order to generate more training data has proven to be very useful, allowing for training of the algorithm to sufficient accuracy utilizing a much smaller number of videos than without the subsetting. However, it is recognized that in some embodiments, entire videos can also be used as input in the training sets.

Explanation of the Differences Between the Data Fed into Training Mode and Inference Mode

In some embodiments, unlike in the training mode, an entire video stream is fed into the neural network one frame at a time in the inference mode. As mentioned above, the network is constructed such that it only explicitly depends on the previous frame, but it implicitly carries information about all the previous frames. Because the dependence on all the previous frames is not explicit (and therefore the data from these previous frames need not be kept in memory), the algorithm is computationally efficient for running on long videos. In practice, implicit dependence of the current frame on all the previous frames has been observed to decay over time.

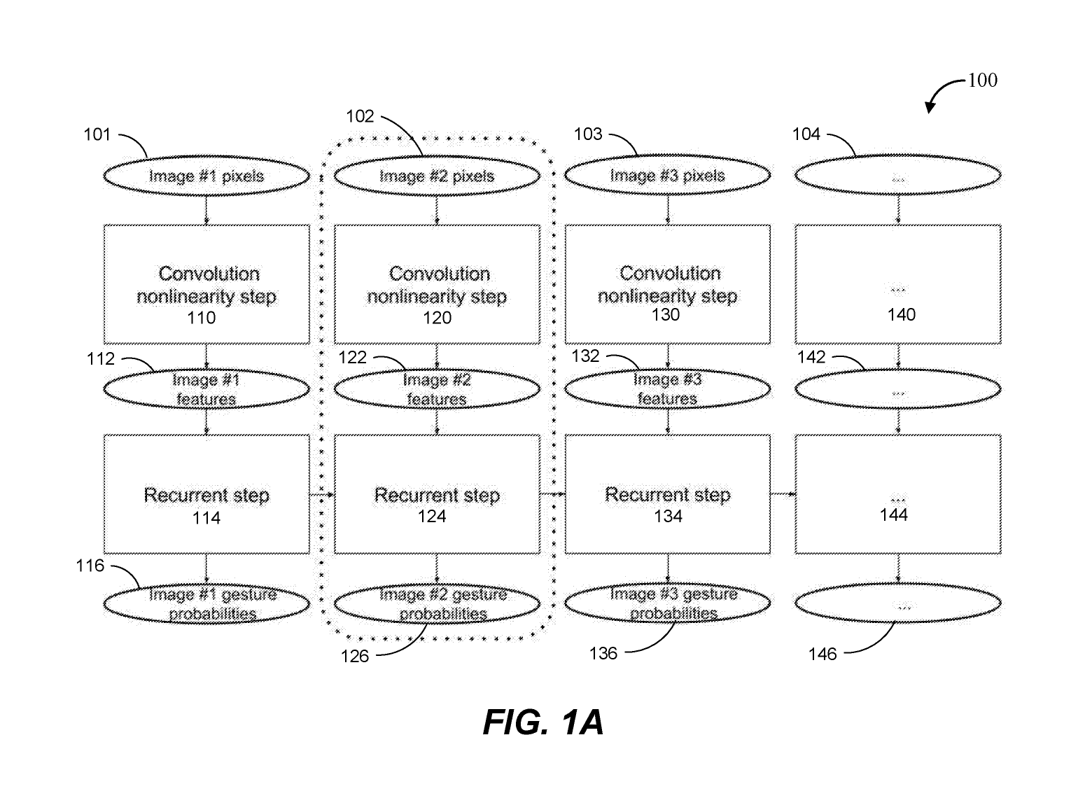

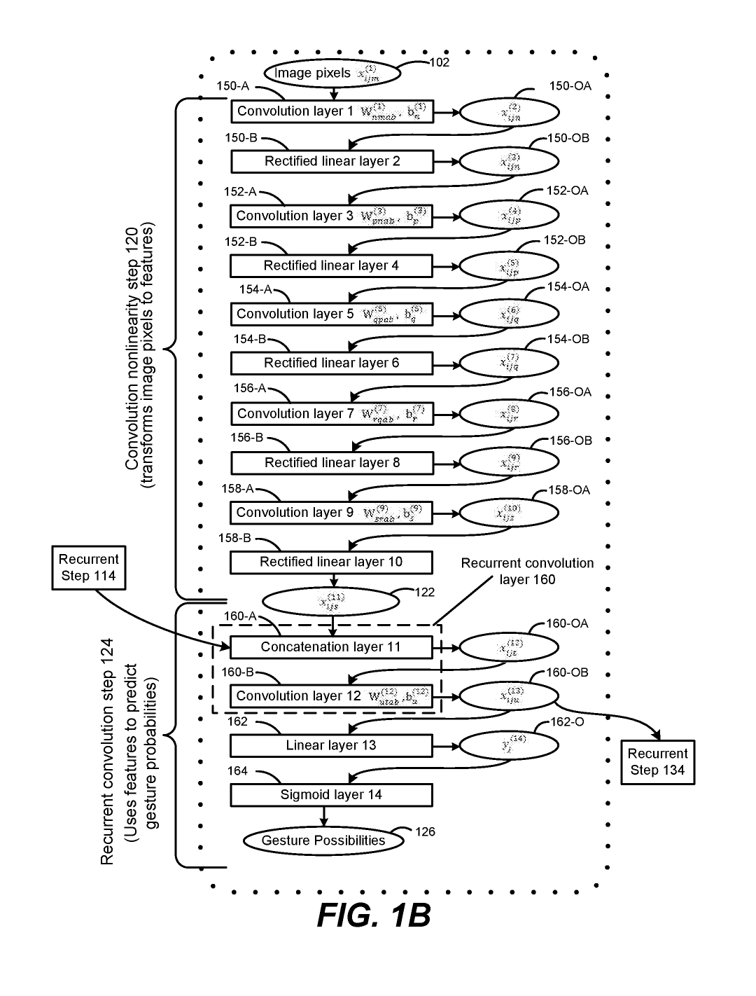

FIGS. 1A and 1B illustrate and example of steps performed for the neural network for gesture recognition. A sequence of images (comprising images 101, 102, 303, and 104) is input into the system one at a time. Image 101 is input as a tensor into the convolution nonlinearity step 110. The output of the convolution nonlinearity step 100 is a feature tensor 112, which is subsequently used as the input for the recurrent step 114. In general, a recurrent step requires a second input tensor. However, because image 101 is the first in the sequence, there is no additional second tensor to input into recurrent step 114, so the second input tensor is taken as all 0's. The output of the recurrent step 114 is a first order tensor 116 containing a probability for each gesture of interest as to whether or not that gesture occurred in image 101. Next, image 102 is used as input to the second convolution nonlinearity step 120 (whose parameters are the same as those in convolution nonlinearity layer 112 and all other convolution nonlinearity layers, such as 130 and 140). The output tensor from convolution nonlinearity layer 120 is feature tensor 122, which is fed into the recurrent step 124. Recurrent step 124 also requires a second input, which is taken from the previous image, specifically the feature tensor output of a recurrent convolution layer of recurrent step 114 (further described with reference to FIG. 1B). However, for purposes of description for FIG. 1A, the second tensor input for recurrent step 124 will be identified as being derived from feature tensor 112. The result of the recurrent step 124 is a first order tensor 126 containing a probability for each gesture of interest as to whether or not that gesture occurred within image 102. Image 103 is fed as a third order tensor as input into convolution nonlinearity step 130. The output of the convolution nonlinearity step 130 is a feature tensor 132. Feature tensor 132 and a feature tensor derived from feature tensor 122 (from the previous image) are fed as the first and second inputs (respectively) into recurrent step 134, whose output is a first order tensor 136 containing probabilities that each gesture of interest occurred within image 103. Image 104 is similarly fed as a third order tensor as input into convolution nonlinearity step 140. The output of the convolution nonlinearity step 140 is a feature tensor 142. Feature tensor 142 and a feature tensor derived from feature tensor 132 (from the previous image) are fed as the first and second inputs (respectively) into recurrent step 144, whose output is a first order tensor 146 containing probabilities that each gesture of interest occurred within image 104. Any subsequent images may be fed as a third order tensor as input into a subsequent convolution nonlinearity step to undergo the same computational processes.

Convolution nonlinearity step 120 and recurrent step 124 are shown in more detail in FIG. 1B. Image 102 may be input into neural network 100 as an input image tensor, and into convolution nonlinearity step 120. Convolution nonlinearity step 120 comprises convolution layers 150-A, 152-A, 154-A, 156-A, and 158-A. Convolution nonlinearity step 120 also comprises rectified linear layers 150-B, 152-B, 154-B, 156-B, and 158-B. Specifically, image tensor 102 is input into the first convolution layer 150-A of convolution nonlinearity step 120. Convolution layer 150-A produces output tensor 150-OA. Tensor 150-OA is used as input for rectified linear layer 150-B, which yields the output tensor 150-OB. Tensor 150-OB is used as input for convolution layer 152-A, which produces output tensor 152-OA. Tensor 152-OA is used as input for rectified linear layer 152-B, which yields the output tensor 152-OB. Tensor 152-OB is used as input for convolution layer 154-A, which produces output tensor 154-OA. Tensor 154-OA is used as input for rectified linear layer 154-B, which yields the output tensor 154-OB. Tensor 154-OB is used as input for convolution layer 156-A, which produces output tensor 156-OA. Tensor 156-OA is used as input for rectified linear layer 156-B, which yields the output tensor 156-OB. Tensor 156-OB is used as input for convolution layer 158-A, which produces output tensor 158-OA. Tensor 158-OA is used as input for rectified linear layer 158-B, which yields the output tensor 122. In various embodiments, convolution-nonlinearlity step 120 may include more or fewer convolution layers and/or rectified linear layers as shown in FIG. 1B.

Feature tensor 122 is then input into the recurrent step 124 where it is combined with a feature tensor derived from feature tensor 112 produced by recurrent step 114, shown in FIG. 1A. Recurrent step 124 includes a recurrent convolution layer pair 160 comprising a concatenation layer 160-A, and a convolution layer 160-B. Recurrent step further includes linear layer 162 and sigmoid layer 164. Both tensors 122 and 112 are first input into the concatenation layer 160-A of recurrent convolution layer pair 160. Concatenation layer 160-A concatenates the input tensors 122 and 112, and produces an output tensor 160-OA, which is consequently used as input to the convolution layer 160-B of recurrent convolution layer 160. The output of convolution layer 160-B is tensor 160-OB. Tensor 160-OB may be used as a subsequent input into the concatenation layer of a subsequent recurrent step, such as recurrent step 134. Tensor 160-OB is also used as input to linear layer 162. Linear layer 162 has an output tensor 162-O, which is passed through a sigmoid layer 164 to produce the final output probabilities 126 for image 102.

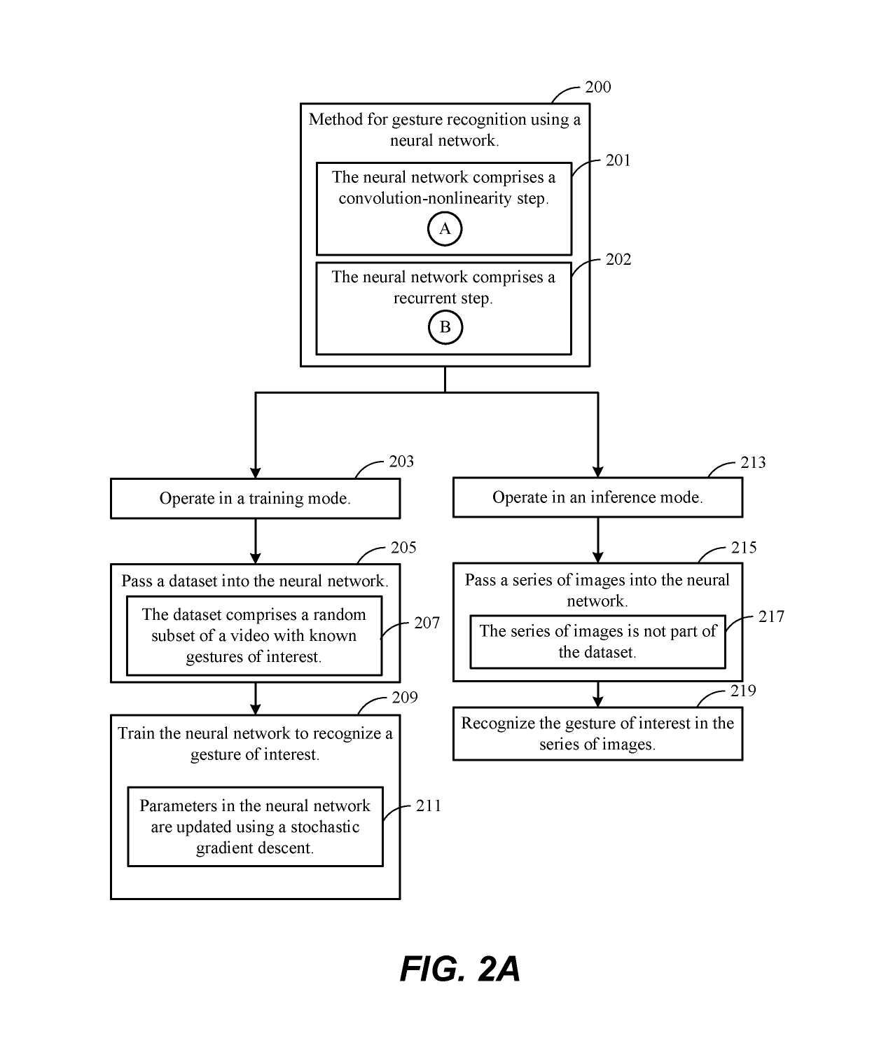

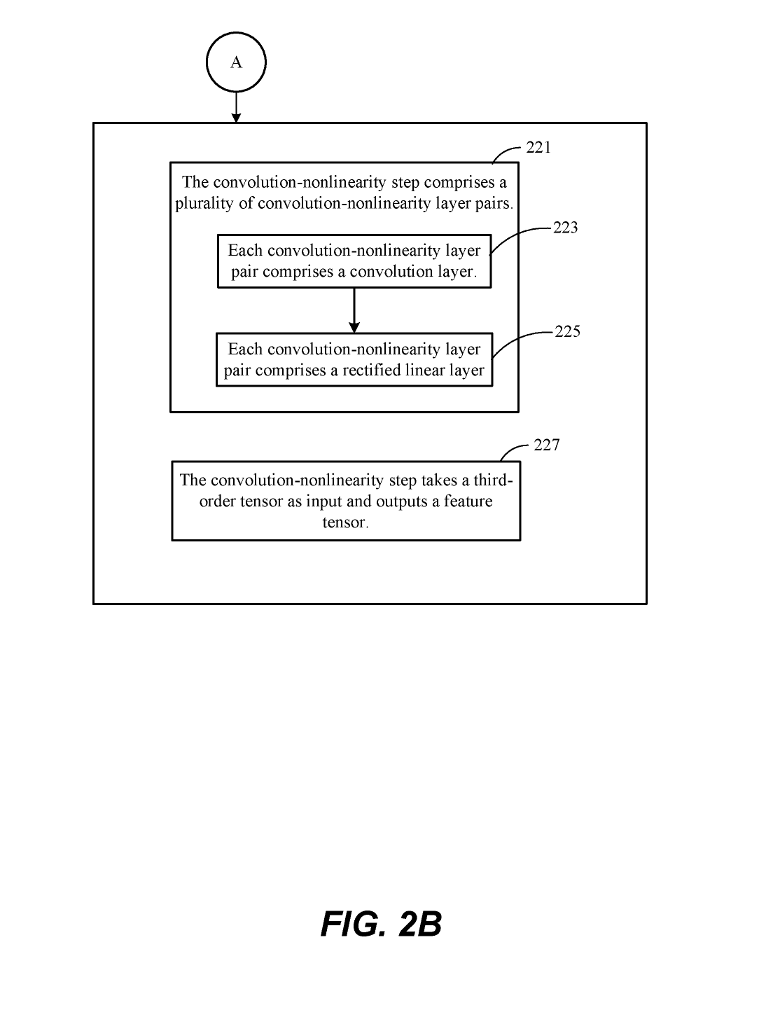

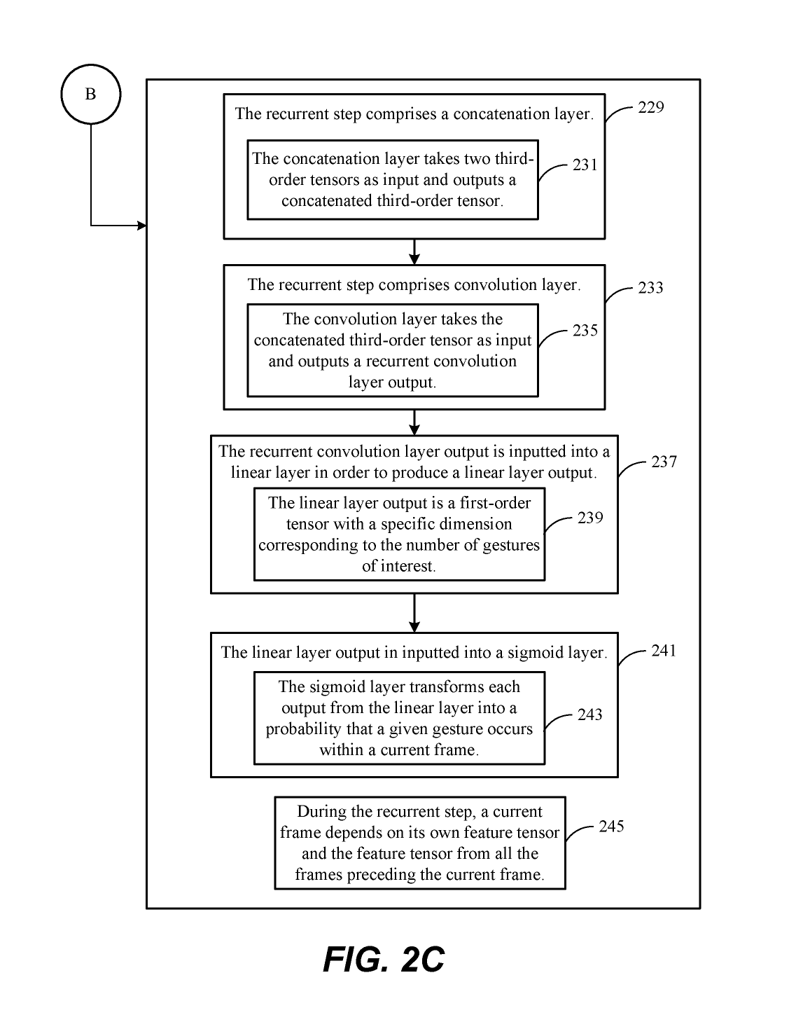

FIGS. 2A, 2B, and 2C illustrate an example of a method 200 for gesture recognition using a neural network, in accordance with one or more embodiments. In certain embodiments, the neural network may be neural network 100. Neural network 100 may comprise a convolution-nonlinearity step 401 and a recurrent step 402. In some embodiments convolution-nonlinearity step 401 may be convolution-nonlinearity step 120 with the same or similar computational layers. In other embodiments, neural network 100 may comprise multiple convolution-nonlinearity steps 401, such as convolution-nonlinearity steps 110, 130, and 140, as described in FIG. 1.

FIG. 2B depicts the convolution-nonlinearity step 201 in method 200, in accordance with one or more embodiments. The convolution-nonlinearity step may comprise a convolution layer and a rectified linear layer. In some embodiments, the convolution-nonlinearity step may comprise a plurality of convolution-nonlinearity layer pairs 221. In some embodiments, neural network 100 may include only one convolution-nonlinearity layer pair 221. Each convolution-nonlinearity layer pair may comprise a convolution layer 223 followed by a rectified linear layer 225. In some embodiments, convolution-nonlinearity layer pair 221 may be convolution-nonlinearity layer pair 150. In some embodiments, convolution layer 223 may be convolution layer 150-A. In some embodiments, rectified linear layer 225 may be rectified linear layer 150-B. In some embodiments, the convolution-nonlinearity step 201 takes a third-order tensor, such as image pixels 102, as input and outputs a feature tensor, such as feature tensor 122.

FIG. 2C depicts the recurrent step 202 in method 200, in accordance with one or more embodiments. In some embodiments, recurrent step 202 may be recurrent step 124 with the same or similar computational layers. In other embodiments, neural network 100 may comprise multiple recurrent steps 202, such as recurrent steps 114, 134, and 144, as described in FIG. 1. In some embodiments, recurrent step comprises a concatenation layer 229 followed by a convolution layer 233. In some embodiments, concatenation layer 229 may be concatenation layer 160-A. In some embodiments, convolution layer 233 may be convolution layer 160-B. In some embodiments, the concatenation layer 229 takes two third-order tensors as input and outputs a concatenated third-order tensor 231. In some embodiments concatenated third-order tensor 231 may be output 160-OA. In an embodiment, the two third-order tensor inputs may include feature tensor 122 and a feature tensor from the convolution layer of a previous recurrent step, such as recurrent step 114. In some embodiments, the convolution layer 233 takes the concatenated third-order tensor 231 as input and outputs a recurrent convolution layer output 235. In some embodiments, recurrent convolution layer output 235 may be output 160-OB.

In some embodiments, the recurrent convolution layer output 235 is inputted into a linear layer 237 in order to produce a linear layer output 239. In some embodiments, linear layer output 239 may be output 162-O. In some embodiments, linear layer output 239 may be a first-order tensor with a specific dimension corresponding to the number of gestures of interest. In further embodiments, the linear layer output 239 is inputted into a sigmoid layer 241. In some embodiments, sigmoid layer 241 may be sigmoid layer 164. In some embodiments, sigmoid layer 241 transforms each output 239 from the linear layer into a probability 243 that a given gesture occurs within a current frame 245. In some embodiments, probability 243 may be gesture probabilities 126. During the recurrent step in certain embodiments, a current frame 245 depends on its own feature tensor and the feature tensor from all the frames preceding the current frame.

Neural network 100 may operate in a training mode 203 and an inference mode 213. When operating in the training mode 203, a dataset is passed into the neural network 100 at 205. In some embodiments, the dataset may comprise a random subset 207 of a video with known gestures of interest. In some embodiments, passing the dataset into the neural network 100 may comprise inputting the pixels of each image, such as image pixels 102, in the dataset as third-order tensors into a plurality of computational layers, such as those described above and in FIG. 1B. At 209, neural network is trained to recognize a gesture of interest. During the training mode 203 in certain embodiments, parameters in the neural network 100 may be updated using a stochastic gradient descent 211. In some embodiments, neural network 100 is trained until neural network 100 recognizes gestures at a predefined threshold accuracy rate. In various embodiments, the specific value of the predefined threshold may vary and may be dependent on various applications.

In various embodiments, neural network 100 may identify and track particular objects, such as hands, fingers, arms, and/or faces to recognize a particular gesture. However, in some embodiments, the system is not explicitly programmed and/or instructed to do so. In some embodiments, identification of such particular objects may be a result of the update of parameters of neural network 100, for example by stochastic gradient descent 211.

As previously described, in other embodiments, neural network 100 may work in conjunction and/or utilize various methods of object detection, such as the neural network detection system described in the U.S. patent application titled SYSTEM AND METHOD FOR IMPROVED GENERAL OBJECT DETECTION USING NEURAL NETWORKS, previously referenced above. As also previously described, neural network 100 may work in conjunction and/or utilize various methods of object tracking, such as the tracking system as described in the U.S. patent application entitled SYSTEM AND METHOD FOR DEEP-LEARNING BASED OBJECT TRACKING, previously referenced above.

In yet further embodiments, the distance and velocity of such particular objects may also be utilized to recognize particular gestures. For example, the distance of a finger and/or the speed at which a hand moves may be recognized by neural network 100 as a particular gesture. Such distance and velocity estimation may be performed by the position estimation may be performed by a distance estimation system as described in the U.S. patent application entitled SYSTEM AND METHOD FOR IMPROVED DISTANCE ESTIMATION OF DETECTED OBJECTS, previously referenced above.

Once neural network 100 is deemed to be sufficiently trained, neural network 100 may be used to operate in the inference mode 213. When operating in the inference mode 213, a series of images 217 is passed into the neural network at 215. The series of images 217 is not part of the dataset from step 205. In some embodiments, the pixels of image 217 are input into neural network 100 as third-order tensors, such as image pixels 102. In some embodiments, the image pixels are input into a plurality of computational layers within convolution-nonlinearity step 201 and recurrent step 202 as described in step 205. At 219, the neural network 100 recognizes the gesture of interest in the series of images.

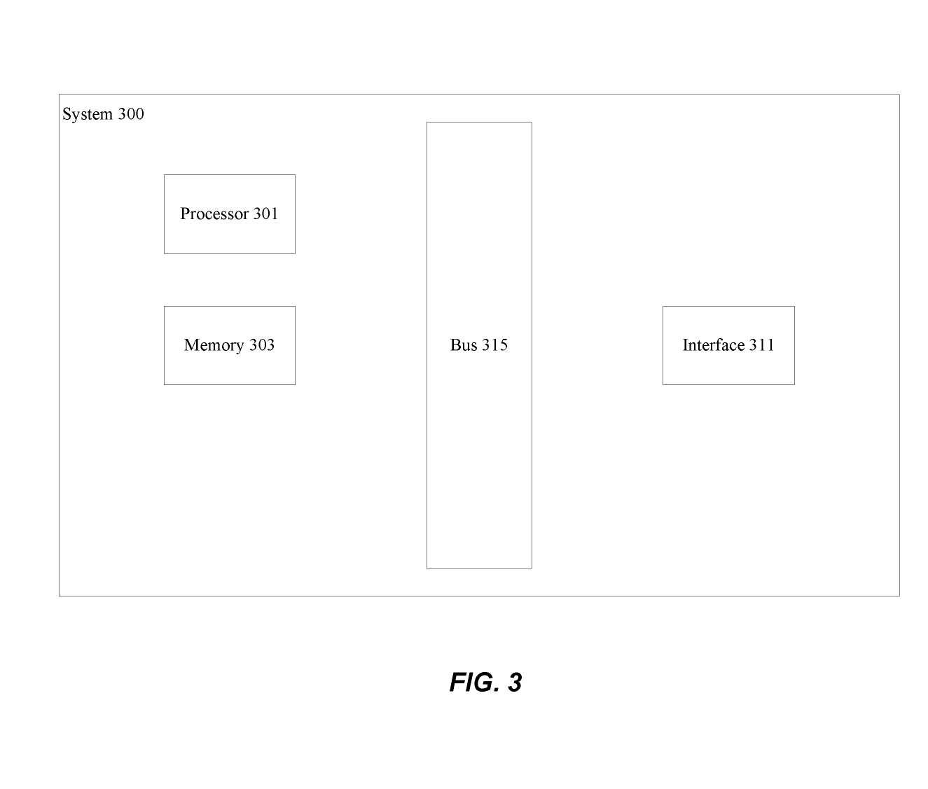

FIG. 3 illustrates one example of a neural network system 300, in accordance with one or more embodiments. According to particular embodiments, a system 300, suitable for implementing particular embodiments of the present disclosure, includes a processor 301, a memory 303, an interface 311, and a bus 313 (e.g., a PCI bus or other interconnection fabric) and operates as a streaming server. In some embodiments, when acting under the control of appropriate software or firmware, the processor 301 is responsible for various processes, including processing inputs through various computational layers and algorithms. Various specially configured devices can also be used in place of a processor 301 or in addition to processor 301. The interface 311 is typically configured to send and receive data packets or data segments over a network.

Particular examples of interfaces supports include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to particular example embodiments, the system 200 uses memory 203 to store data and program instructions for operations including training a neural network, object detection by a neural network, and distance and velocity estimation. The program instructions may control the operation of an operating system and/or one or more applications, for example. The memory or memories may also be configured to store received metadata and batch requested metadata.

Because such information and program instructions may be employed to implement the systems/methods described herein, the present disclosure relates to tangible, or non-transitory, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

While the present disclosure has been particularly shown and described with reference to specific embodiments thereof, it will be understood by those skilled in the art that changes in the form and details of the disclosed embodiments may be made without departing from the spirit or scope of the present disclosure. It is therefore intended that the present disclosure be interpreted to include all variations and equivalents that fall within the true spirit and scope of the present disclosure. Although many of the components and processes are described above in the singular for convenience, it will be appreciated by one of skill in the art that multiple components and repeated processes can also be used to practice the techniques of the present disclosure.

What is claimed is:

1. A method for gesture recognition using a neural network, the method comprising:
in a training mode:
passing a dataset into the neural network;
training the neural network to recognize a gesture of interest, wherein
the neural network includes a convolution-nonlinearity step and a recurrent step;
in an inference mode:
passing a series of images into the neural network, wherein the series of images is not part of the dataset;
recognizing the gesture of interest in the series of images.

2. The method of claim 1, wherein the dataset comprises a random subset of a video with known gestures of interest.

3. The method of claim 1, wherein the convolution-nonlinearity step comprises a convolution layer and a rectified linear layer.

4. The method of claim 1, wherein the convolution-nonlinearity step takes a third-order tensor as input and outputs a feature tensor.

5. The method of claim 1, wherein the convolution-nonlinearity step comprises a plurality of convolution-nonlinearity layer pairs, each convolution-nonlinearity layer pair comprising a convolution layer followed by a rectified linear layer.

6. The method of claim 1, wherein the recurrent step comprises a concatenation layer followed by a convolution layer, the concatenation layer taking as input two third-order tensors and outputting a concatenated third-order tensor, the convolution layer taking the concatenated third-order tensor as input and outputting a recurrent convolution layer output.

7. The method of claim 6, wherein the recurrent convolution layer output is inputted into a linear layer in order to produce a linear layer output, the linear layer output being a first-order tensor with a specific dimension corresponding to the number of gestures of interest.

8. The method of claim 7, wherein linear layer output is inputted into a sigmoid layer, the sigmoid layer transforming each output from the linear layer into a probability that a given gesture occurs within a current frame.

9. The method of claim 1, wherein during the recurrent step, a current frame depends on its own feature tensor and the feature tensor from all the frames preceding the current frame.

10. The method of claim 1, wherein, during the training mode, parameters in the neural network are updated using a stochastic gradient descent.

11. A system for gesture recognition using a neural network, comprising:
one or more processors;
memory; and
one or more programs stored in the memory, the one or more programs comprising instructions to operate in a training mode and an inference mode;
wherein in the training mode, the one or more programs comprise instructions for:
passing a dataset into the neural network;
training the neural network to recognize a gesture of interest, wherein the neural network includes a convolution-nonlinearity step and a recurrent step;
wherein in the inference mode, the one or more programs comprise instructions to:
passing a series of images into the neural network, wherein the series of image is not part of the dataset; and
recognizing the gesture of interest in the series of images.

12. The system of claim 11, wherein the dataset comprises a random subset of a video with known gestures of interest.

13. The system of claim 11, wherein the convolution-nonlinearity step comprises a convolution layer and a rectified linear layer.

14. The system of claim 11, wherein the convolution-nonlinearity step takes a third-order tensor as input and outputs a feature tensor.

15. The system of claim 11, wherein the convolution-nonlinearity step comprises a plurality of convolution-nonlinearity layer pairs, each convolution-nonlinearity layer pair comprising a convolution layer followed by a rectified linear layer.

16. The system of claim 11, wherein the recurrent step comprises a concatenation layer followed by a convolution layer, the concatenation layer taking as input two third-order tensors and outputting a concatenated third-order tensor, the convolution layer taking the concatenated third-order tensor as input and outputting a recurrent convolution layer output.

17. The system of claim 16, wherein the recurrent convolution layer output is inputted into a linear layer in order to produce a linear layer output, the linear layer output being a first-order tensor with a specific dimension corresponding to the number of gestures of interest.

18. The system of claim 17, wherein linear layer output is inputted into a sigmoid layer, the sigmoid layer transforming each output from the linear layer into a probability that a given gesture occurs within a current frame.

19. The system of claim 11, wherein during the recurrent step, a current frame depends on its own feature tensor and the feature tensor from all the frames preceding the current frame.

20. A non-transitory computer readable storage medium storing one or more programs configured for execution by a computer, the one or more programs comprising instructions to operate in a training mode and an inference mode;
wherein in the training mode, the one or more programs comprise instructions for:
passing a dataset into the neural network;
training the neural network to recognize a gesture of interest, wherein the neural network includes a convolution-nonlinearity step and a recurrent step;
wherein in the inference mode, the one or more programs comprise instructions to:
passing a series of images into the neural network, wherein the series of image is not part of the dataset; and
recognizing the gesture of interest in the series of images.
